(19) United States
(12) Patent Application Publication
(10) Pub. No.: US 2014/0136598 A1
(43) Pub. Date: May 15, 2014

(54) Global Super Store

(71) Applicant: Anuthep Benja-Athon, New York, NY (US)

(72) Inventor: Anuthep Benja-Athon, New York, NY (US)

(21) Appl. No.: 13/678,096

(22) Filed: Nov. 15, 2012

(51) Int. Cl. H04L 29/06

(52) U.S. Cl. CPC H04L 67/42
USPC 709/203

(57) ABSTRACT

A system and method for networked display screens and flat-panel displays to generate, send, receive, stream, push, exchange, shuffle, intermingle, compose, influence and download digital contents to and from, between and among servers-processor units (SPU) selected networked display screens and flat-panel displays in networks of display screens and flat-panel displays affixed to surfaces of diverse public places and domains. The networked display screens and flat-panel displays for targeting networked desktops and mobile devices in the system and method for expediting and enhancing trades, commerce, businesses and transactions of goods and services between and among SPU-selected and targeted display screens and flat-panel displays, desktops and mobile devices.

### FIELD OF THE INVENTION

A system and method for networks of display screens and flat-panel displays to direct and guide global commerce, trades and transactions of goods and services.

### BACKGROUND OF THE INVENTION

Despite technological advances, there exists no platform for domestic and global commerce, trades, businesses and transactions of domestic and global goods and services for, between and among millions of enterprises and people in individual nations and billions of enterprises and people on the planet. Consequently, immense wastes and losses of resources and time for said enterprises and people and an immense obstacle for improving and advancing people and human civilization.

The present invention provides a global network or networks of networked display screens and flat-panel displays affixed to surfaces in diverse public places and domains on the planet for millions of enterprises and people in individual nations and billions of enterprises and people. This global networks networked display screens and flat-panel displays networked to cloud computing servers for creating and providing a global Web of electronic conduits for enabling and causing individual networked originating display screens and individual originating flat-panel displays to generate, direct and guide specific digital contents to and from, between and among targeted and servers-processor units (SPU) selected relevant individual networked receiving display screens and individual receiving flat-panel displays in networks of said networked display screens and flat-panel displays.

The present invention provided millions of said networked display screens and flat-panel displays also target and influence billions of networked desktops, televisions and mobile communication devices and equipment and vice versa. Said networked display screens and flat-panel displays and targeted desktops, televisions and mobile communication devices and equipment henceforth networked devices for specifying and instructing networked servers to generate, send, receive, stream, push, exchange, shuffle, intermingle, compose, influence and download SPU-selected specific digital contents to and from, between and among said networked devices constituents in said individual adaptable satellites in a constellation of individual adaptable satellites. Said constellation for generating, guiding and exchanging SPU-selected specific digital contents for enabling and effecting, directing, guiding and promoting domestic and international commerce, trades, businesses and transactions of domestic and global goods and services for, between and among billions of SPU-targeted enterprises and people on the planet.

By SPU creating and growing SPU-generated big data on said networked devices, enterprises, owners, human viewers and users of said networked devices compiled by SPU herein in said cloud computing servers and by applying said SPU-generated big data and analytics and statistics of said big data, the present invention provides a machine-learning system and method for creating, growing and adapting said SPU-generated big data from continual inputs of immense and complete data described infra from said networked devices to said SPU and into memories to the inevitable and eventual extent that said machine-learning and cloud computing-automated system and method automatically operate, sustain, support, grow and perpetuate the system, processes, objectives and outcomes described herein to represent one of the preferred embodiments of the present invention.

### SUMMARY OF THE INVENTION

The present invention is a cloud computing system and method for networked display screens and flat-panel displays for generating, sending, receiving, streaming, pushing, exchanging, shuffling, intermingling, composing, influencing and downloading digital contents to generate, send, receive, stream, push, exchange, shuffle, intermingle, compose, influence and download digital contents to and from, between and among SPU-selected networked display screens and flat-panel displays in networks of display screens and flat-panel displays affixed to surfaces of diverse public places and domains. Individual networked display screens and individual flat-panel displays target networked desktops, mobile devices and televisions for generating, sending, receiving, exchanging, shuffling, intermingling, composing, influencing and downloading digital contents to and from, between and among said networked devices in the system and method for expediting and enhancing trades, commerce, businesses and transactions of goods and services between and among SPU-selected and targeted display screens and flat-panel displays, desktops, mobile devices and televisions.

The present invention endowed said networked display screens and flat-panel displays including digital mirrors and glass, remote servers, computers and mobile devices including laptops, computer tablets, cellular phones and smartphones with viewing screens including touchscreens and infrared light sensor and voice-activated display screens, flat-panel displays and digital mirrors and glass and commercially available technologies, codes, QR codes, images and means for enabling said devices to communicate and exchange, shuffle information and data including electronic transactions including the consummations of trades, commerce, businesses and/or transactions of goods and services and electronic payments and transfers of payments and funds between and among said devices and constituents of said adaptable satellites by cable means, wireless means, near-field communications technologies, display screen, flat-panel display, desktop, mobile device and television apps, downloads and technologic streams and pushes.

### DESCRIPTION OF THE PREFERRED EMBODIMENTS

The present invention provides a machine-learning and machine-intelligent system and method for creating, growing and adapting said SPU-generated big data from continual inputs of immense and diverse digital contents including elements and details described infra from said networked devices and enterprises and people viewing and using said networked devices to said SPU and into memories to the inevitable and eventual extent that said machine-learning, machine-intelligent and cloud computing-automated system and method automatically operate, sustain, support, grow and perpetuate the system, processes, objectives and outcomes described herein to represent one of the preferred embodiments of the present invention.

The present invention provides a system of networked display screens and flat-panel displays, digital mirrors and glass affixed to surfaces of diverse public places and domains on the planet earth, said networked display screens and flat-panel displays further networked to targeted remote display screens and flat-panel displays, and said networked display screens and flat-panel displays are networked to remote servers, desktops, televisions and mobile devices such as, but not limited to laptops, computer tablets, cellular phones and smartphones, said networked display screens, flat-panel displays, remote servers, desktops, mobile devices and televisions having cable and wireless networking capabilities, cloud-computing, machine intelligence, near-field communications and/or social-networking technologies for enabling said desktops, mobile devices and televisions to interact and communicate with said display screens and flat-panel displays, and vice versa, henceforth networked originating devices, active receiving devices and passive receiving devices henceforth networked devices in an ecosystem of said networked devices for generating said digital contents and maintaining, changing and/or adapting a global Web of electronic conduits for directing and guiding specific digital contents to and displaying said specific digital contents in targeted networked display screens and flat-panel displays, and, furthermore, said targeted networked display screens and flat-panel displays for directing and guiding specific digital contents to and displaying said specific digital contents in targeted networked desktops, mobile devices and televisions being used and/or related to targeted enterprises, owners, human viewers and users of said specific digital contents in said networked devices in any and all places and domains on the planet. The system and method of the present invention direct and guide domestic and global commerce, trades, businesses and transactions of goods and services for millions of enterprises and people in individual nations and billions of enterprises and people on the planet.

Said networked devices for sending, receiving, streaming, pushing, exchanging, shuffling, intermingling, composing, influencing and/or downloading images, individual images of individual compositions of images, videos, audio, voice and digital data including advertisements henceforth digital contents to and from, by, between and among said networked devices in diverse public places and domains in any and all nations on the planet. Said diverse and wide spectrum of digital contents are generated, sent, received, exchanged, shuffled, intermingled, composed, influenced and/or downloaded to and from, by, between and among said targeted devices being used by billions of targeted enterprises and people in diverse places and domains in any and all nations on the planet.

Said networked devices for interacting and communicating with servers-processor units (SPU) selected and targeted networked devices and enterprises, owners, human viewers and/or users of said digital contents henceforth an adaptable satellite (a metaphor) in a constellation (a metaphor) of individual adaptable satellites, said individual adaptable satellites having and projecting a sphere of influence over SPU-selected, targeted and/or relevant networked devices constituents and enterprises, owners, human viewers and users in said diverse public places and domains on the planet, said mobile devices capable of influencing digital contents in said screens and displays, and said display screens and flat-panel displays capable of causing digital contents of said display screens and flat-panel displays to be downloaded to said mobile devices, a constellation of individual adaptable satellites with overlapping individual spheres of influence, said system for causing, enabling, expediting and enhancing trades, commerce, businesses and/or services by, for and among said SPU-selected and targeted millions of enterprises and billions of human viewers and/or users using and/or related to said networked devices.

Specifically, the present invention is a system of networked display screens and flat-panel displays for directing and guiding specific digital contents to and from and displaying said specific digital contents in targeted networked receiving display screens and flat-panel displays for directing and guiding specific digital contents to and from and displaying said specific digital contents in targeted networked receiving display screens and flat-panel displays including said networked originating display screens and flat-panel displays in networks of said display screens and flat-panel displays affixed to surfaces of diverse public places and domains. Said networked originating display screens and flat-panel displays for specifying and instructing servers-processor units (SPU) of networked remote servers how to select relevant said networked display screens and flat-panel displays for generating, sending, receiving, exchanging, shuffling, intermingling, composing, influencing and downloading said digital contents to and from, between and among said networked originating display screens and flat-panel displays in networks of said networked devices. In other words, said networked originating display screens and flat-panel displays specifying and instructing said SPU how to select relevant networked active and passive receiving display screens and flat-panel displays to send, receive, exchange, shuffle, intermingle, compose, influence and download digital contents to and from, between and among said networked originating and receiving display screens and flat-panel displays. Furthermore, said SPU for selecting relevant networked originating devices and receiving devices although processor units of said networked originating devices and receiving devices can be technologically configured to behave and function like said SPU to select relevant and network networked originating devices and receiving devices.

Said SPU-selected relevant networked active receiving display screens and flat-panel displays specifying and instructing said SPU how to select relevant networked active receiving display screens and flat-panel displays including said networked originating display screens and flat-panel displays and networked passive receiving devices to send, receive, exchange, shuffle, intermingle, compose, influence and download digital contents to and from, between and among said networked active receiving and originating display screens and flat-panel displays. Yet furthermore, said networked originating and receiving display screens and flat-panel displays target relevant SPU-selected networked desktops, hand-held and mobile communication devices and televisions for influencing and adapting said digital contents in, between and among said networked devices in individual adaptable satellites.

Said adaptable satellites and servers comprising cable and wireless networking capabilities, cloud-computing, near-field communications and social-networking technologies and said servers and devices comprising processors units coupled to memories.

Said processors units attached to:

i. a mechanism for specifying and instructing said processor units how to attach individual identities of said devices constituents to descriptions and definitions of enterprises, owners, intended human viewers and/or users of said devices and how to attach said individual identities of said devices constituents to digital contents, how to attach said digital contents to descriptions and definitions of enterprises, owners, intended human viewers and/or users of said digital contents;
ii. a mechanism for specifying and instructing said processor units how to generate, grow and adapt said SPU-generated big data comprising identities of individual networked devices, descriptions and definitions of individual enterprises, owners, intended human viewers and/or users of said networked devices, individual digital contents originating from said individual networked devices, and descriptions and definitions of individual enterprises, owners, intended human viewers and users of said digital contents being generated, submitted and adapted by said networked devices in said networks and how to output said SPU-generated big data to said memories;
iii. a mechanism for specifying and instructing said processor units how to apply said SPU-generated big data and analytics and statistics of said big data to constitute said networked originating devices and active receiving devices for generating, sending, receiving, streaming, pushing, exchanging, shuffling, intermingling, composing, influencing and downloading digital contents to and from, between and among said networked devices constituents;
iv. a mechanism for specifying and instructing said processor units how to apply said SPU-generated big data and analytics and statistics of said big data to constitute said networked devices constituents for sending, receiving, streaming, pushing, exchanging, shuffling, intermingling, composing, influencing and/or downloading said digital contents to and from, by, between and among said networked devices constituents;
v. a mechanism for specifying and instructing said processor units how to apply said SPU-generated big data and analytics and statistics of said big data to constitute said networked originating display screens and flat-panel displays for generating, sending, receiving, exchanging, shuffling, intermingling, composing, influencing and downloading digital contents to and from, between and among said SPU select relevant networked originating and receiving display screens and flat-panel displays;
vi. a mechanism for specifying and instructing desktops, mobile devices and television how to influence and adapt digital contents in display screens and flat-panel displays;
vii. a mechanism for specifying and instructing said processor units how to apply said SPU-generated big data and analytics and statistics of said big data to cause digital contents in display screens and flat-panel displays to be downloaded to and displayed in said SPU-selected desktops, mobile devices and televisions;
viii. a mechanism for specifying and instructing said processor units how to apply said SPU-generated big data and analytics and statistics of said big data to select networked originating and receiving display screens and flat-panel displays for specifying and instructing said SPU how to select relevant networked originating devices, active receiving devices and passive receiving devices for generating, sending, receiving, exchanging, shuffling, intermingling, composing, influencing and downloading digital contents to and from, between and among said networked devices;
ix. a mechanism for specifying and instructing said SPU how to cause said servers to send, receive, stream, push, exchange, shuffle, intermingle, compose, influence and download said digital contents to and from, between and among said networked devices in said individual adaptable satellites in diverse public places and domains;
x. a mechanism for specifying and instructing said SPU how to cause said remote servers to generate, send, receive, stream, push, exchange, shuffle, intermingle, compose, influence and download digital contents to and from, between and among SPU select relevant networked originating devices, active receiving devices and passive receiving devices in individual adaptable satellites;
xi. a mechanism for specifying and instructing said processor units how to deselect selected devices constituents in said individual adaptable satellites;
xii. a mechanism for specifying and instructing said SPU to learn how to grow and adapt said SPU-generated big data from continual inputs of said data from said networked devices to said SPU and into memories and how to apply said SPU-generated big data and analytics and statistics of said big data and analytics and statistics of said big data to automatically operate, sustain, support, grow and perpetuate said system, method, processes and outcomes generated by, between and among said networked devices;
xiii. a mechanism for specifying and instructing said processor units how to adapt, assigning and/or relocating individual devices constituents of, between and among individual adaptable satellites in said constellation of adaptable satellites to adapt and change individual spheres of influence;
xiv. a mechanism for specifying and instructing said SPU to recombine and/or adapt said SPU-generated big data and analytics and statistics of said big data from submissions, adaptations, analytics and combinations generated and submitted by said networked devices constituents in said individual adaptable satellites and changing devices constituents in said individual adaptable satellites.

Data on individual identities of said devices constituents are input by said networked devices to said SPU.

Data on individual descriptions and definitions of individual enterprises, owners, viewers and users of said networked devices are input by individual enterprise owners, human owners, viewers and users of said display screens and flat-panel displays and networked or related desktops, mobile devices and televisions for accepting and outputting said data to said SPU said individual descriptions and definitions of said owners', viewers' and users' demographics such as, but not limited to, socioeconomic information, genders, ages, ethnicity, features, preferences, life styles, health and healthcare information, diets, nutrition, medications, religions, believes, avocations, hobbies, interests, places of living and works, etc. Said data in great and comprehensive details are submitted to said SPU.

Data on individual descriptions and definitions of individual enterprise owners, human owners, viewers and users of said digital contents are input by individual enterprise owners, human owners, viewers and users of said display screens and flat-panel displays and networked or related desktops, mobile devices and televisions for accepting and outputting said data to said SPU said individual descriptions and definitions of said owners', viewers' and users' demographics such as, but not limited to, socioeconomic information, genders, ages, ethnicity, features, preferences, life styles, health and healthcare information, diets, nutrition, medications, religions, believes, avocations, hobbies, interests, places of living and works, etc. Said data in great and comprehensive details are submitted to said SPU.

The present invention provides for machine intelligence for said SPU to generate, expand and adapt said SPU-generated big data and analytics and statistics of said big data from said data which are continually generated and submitted to said SPU and memories by said networked display screens, flat-panel displays, remote servers, desktops, mobile devices and televisions in said ecosystem on the planet.

Individual elements comprise details, elements, demographics, features, illustrations, properties, characteristics, themes, expressions, impressions, perceptions, contents, compositions and any combinations thereof of individual images, compositions of images, videos, audio, voice and digital data, national and international business customs and practices, laws, rules and regulations, etc. Said elements are also incorporated into said big-data analytics and statistics for assisting machine and human decisions makings and derived hybrid of the present invention.

One of the preferred embodiments of said SPU generating said SPU-generated big data in said memories comprises processes for said SPU:

i. attaching descriptions and definitions of individual enterprises, owners, human viewers and/or users of individual networked originating devices to identities of said individual networked originating devices, attaching identities of individual networked originating devices to individual digital contents originating in said individual networked originating devices and attaching said individual digital contents to descriptions and definitions of individual enterprises, owners, human viewers and/or users of said individual digital contents;
ii. attaching descriptions and definitions of individual enterprises, owners, human viewers and/or users of individual networked active receiving devices to identities of said individual networked active receiving devices, attaching identities of individual networked active receiving devices to individual digital contents originating in said individual networked active receiving devices and attaching said individual digital contents to descriptions and definitions of individual enterprises, owners, human viewers and/or users of said individual digital contents;
iii. attaching descriptions and definitions of individual enterprises, owners, human viewers and/or users of individual networked passive receiving devices to identities of individual networked passive receiving devices;
iv. attaching individual identities of networked originating devices attaching to individual digital contents to individual identities of networked active receiving devices having attached same, similar or equivalent individual descriptions and definitions of enterprises, owners, human viewers and/or users of said individual digital contents and attaching said individual digital contents having said attached same, similar or equivalent individual descriptions and definitions of enterprises, owners, human viewers and/or users of said individual digital contents to said networked devices;
v. attaching individual identities of networked originating devices attaching to individual digital contents to individual identities of networked active receiving devices having attached same, similar or equivalent individual descriptions and definitions of enterprises, owners, human viewers and/or users of individual components of said individual digital contents and attaching said individual digital contents having said attached same, similar or equivalent individual descriptions and definitions of enterprises, owners, human viewers and/or users of said individual components of to said networked devices;
vi. attaching individual identities of networked originating devices attaching to individual digital contents to individual identities of networked active receiving devices having attached same, similar or equivalent individual descriptions and definitions of enterprises, owners, human viewers and/or users of individual components of said individual digital contents and attaching said individual components having said attached same, similar or equivalent individual descriptions and definitions of enterprises, owners, human viewers and/or users of said individual components to said networked devices; and
vii. attaching individual identities of networked originating devices attaching to individual digital contents to individual identities of networked active receiving devices having attached same, similar or equivalent individual descriptions and definitions of enterprises, owners, human viewers and/or users of individual elements of individual components of said individual digital contents and attaching said individual elements having said attached same, similar or equivalent individual descriptions and definitions of enterprises, owners, human viewers and/or users of said individual elements of to said networked devices.

One of the preferred embodiments of said adaptable and growing SPU-generated big data and analytics and statistics of said big data from continual inputs of said data from said networked devices into said SPU and memories—an embodiment of machine intelligence—of said servers networked to said networked devices on the planet comprising:

i. relations comprising identities of individual networked originating devices, identities of individual active receiving devices and identities of individual passive receiving devices, descriptions and definitions of individual enterprises, owners, intended human viewers and/or users of said individual networked devices, individual digital contents and descriptions and definitions of enterprises, owners, intended human viewers and/or users of said digital contents;
ii. data generated by said display screens and flat-panel displays having touch-screens henceforth touchscreens, cameras, infrared light sensors, facial-, fingerprint-, retinal-, voice- and speech-recognition means for machine recognizing and categorizing individual owners, viewers and users, said individual descriptions and definitions of said owners', viewers' and users' demographics such as, but not limited to, socioeconomic information, genders, ages, ethnicity, features, preferences, life styles, health and healthcare information, diets, nutrition, medications, religions, believes, avocations, hobbies, interests, places of living and works including country codes, telephone country and city codes and postal zip codes, email and networked addresses, etc. and voice-activated and speech-recognition means for enabling said devices to interact with and among said devices, enterprises, owners, human viewers and users, commercially available technologies, social-networking technologies, near-field communications technologies, mobile payments technologies, facial, fingerprint, retinal, speech, voice and genes recognitions and motion analysis technologies, display screen, flat-panel display, desktop, mobile device and television apps, downloads and technologic streaming and pushing, QR codes, codes, images and means for enabling said devices to communicate, exchange, transfer, download and shuffle information and data including electronic transactions including the transactions of trades, commerce, businesses and/or transactions of goods and services, information and data and electronic payments and transfers of payments and funds in, between and among said devices, said funds are deposited in banks and/or individual viewers' and/or users' escrow accounts in, between and among said devices, said data are submitted to said SPU by said display screens and flat-panel displays;
iii. relations of individual descriptions and definitions of enterprises, owners, human viewers and/or users, individual identities of networked originating devices using said originating devices, said individual identities of networked originating devices, individual digital contents and attaching said individual digital contents and individual descriptions and definitions of enterprises, owners, human viewers and/or users said individual digital contents;
iv. relations of individual descriptions and definitions of enterprises, owners, human viewers and/or users to individual identities of networked active receiving devices using said originating devices, said individual identities of networked active receiving devices, individual digital contents and attaching said individual digital contents and individual descriptions and definitions of enterprises, owners, human viewers and/or users of said individual digital contents;
v. relations of individual descriptions and definitions of enterprises, owners, human viewers and/or users and individual identities of networked passive receiving devices using said passive receiving devices;
vi. relations of individual identities of said networked devices having attached same, similar or equivalent individual descriptions and definitions of enterprises, owners, human viewers and/or users of individual digital contents and said individual digital contents having said attached same, similar or equivalent individual description;
vii. relations of individual identities of said networked devices having attached same, similar or equivalent individual descriptions and definitions of enterprises, owners, human viewers and/or users of individual elements of individual components of individual digital contents and attaching said individual elements of individual components of individual digital contents having said attached same, similar or equivalent individual descriptions and definitions of enterprises, owners, human viewers and/or users to said attached networked devices.

Furthermore, the present invention provides for a mechanism attaching to said SPU to specify and instruct said SPU to learn how to continually grow, synthesize, recombine, adapt, improve and said remote servers how to learn from said SPU-generated big data and analytics and statistics of said big data from submissions and adaptations generated and submitted by said networked devices constituents in said individual adaptable satellites and changing devices constituents in said individual adaptable satellites in said constellation. Consequently, said SPU continually analyze, reattach, change and/or adapt said SPU-generated big data and analytics and statistics of said big data, digital contents in said global Web of electronic conduits for directing and guiding specific digital contents to and displaying said specific digital contents in targeted networked display screens and flat-panel displays, and, furthermore, said targeted networked display screens and flat-panel displays for directing and guiding specific digital contents to and displaying said specific digital contents in targeted networked desktops, mobile devices and televisions related to targeted enterprises, owners, human viewers and users of said specific digital contents, said adaptable global Web of electronic conduits and, consequently, trades, commerce, businesses, transactions of domestic and global goods and services utilizing, depending, relating and/or consequent to said global Web of electronic conduits. Said occurrences, events, matters, consequences and outcomes are caused, perpetuated and sustained by said devices constituents in, between and among said individual adaptable satellites in said constellation.

The present invention provided process for said SPU to apply said SPU-generated big data and analytics and statistics of said big data to constitute said devices constituents in individual adaptable satellites in said networked servers having individual spheres of influence. Said individual networked originating devices and individual active receiving devices to submit individual identities of said active receiving devices, individual descriptions and definitions of enterprises, owners, human viewers and/or users of said individual devices, digital contents, and individual descriptions and definitions of enterprises, owners, human viewers and/or users of said digital contents to said servers processor units in said networked servers. Furthermore, said passive receiving devices to submit individual identities of said passive receiving devices, individual descriptions and definitions of enterprises, owners, human viewers and/or users of said individual devices to said SPU. Said SPU processing said submissions by said networked devices and outputting outcomes as SPU-generated big data and analytics and statistics of said big data in said memories. Said SPU to apply said SPU-generated big data and analytics and statistics of said big data to choose and select networked originating devices, active receiving devices and passive receiving devices for sending, receiving, streaming, pushing, exchanging, shuffling, intermingling, composing, influencing and/or downloading relevant digital contents to and from, by, between and/or among said networked devices in said in individual adaptable satellites.

One of the preferred embodiments of the present invention, said SPU applying said SPU-generated big data and analytics and statistics of said big data to choose and select networked originating devices, active receiving devices and, as described supra, passive receiving devices for sending, receiving, streaming, pushing, exchanging, shuffling, intermingling, composing, influencing and downloading specific and relevant digital contents to and from, by, between and/or among said networked devices. Said preferred embodiment comprises:

i. said individual networked originating devices to generate and submit to said SPU descriptions and definitions of individual enterprises, owners, human viewers and/or users of individual networked originating devices to identities of said individual networked originating devices, identities of individual networked originating devices to individual digital contents originating in said individual networked originating devices and said individual digital contents to descriptions and definitions of individual enterprises, owners, human viewers and/or users of said individual digital contents;
ii. said individual networked active receiving devices to generate and submit to said SPU descriptions and definitions of individual enterprises, owners, human viewers and/or users of individual networked active receiving devices to identities of said individual networked active receiving devices, identities of individual networked active receiving devices to individual digital contents originating in said individual networked active receiving devices and said individual digital contents to descriptions and definitions of individual enterprises, owners, human viewers and/or users of said individual digital contents;
iii. said individual networked passive receiving devices to generate and submit to said SPU descriptions and definitions of individual enterprises, owners, human viewers and/or users of individual networked passive receiving devices to identities of individual networked passive receiving devices;
iv. said SPU processing said submissions and outputting outcomes as SPU-generated big data and analytics and statistics of said big data in said memories;
v. said SPU to apply said SPU-generated big data and analytics and statistics of said big data to select networked originating devices, active receiving devices and passive receiving devices for generating, sending, receiving, streaming, pushing, exchanging, shuffling, intermingling, composing, influencing and/or downloading digital contents to and from, by, between and among said SPU-selected networked devices;
vi. said SPU attaching individual identities of said devices to descriptions and definitions of enterprises, owners, intended human viewers and/or users of said devices and attaching said individual identities of said devices to digital contents, said digital contents attaching to descriptions and definitions of enterprises, owners, intended human viewers and/or users of said digital contents choosing and selecting networked originating devices for sending, receiving, streaming, pushing, exchanging, shuffling, intermingling, composing, influencing and/or downloading relevant first digital contents and active receiving devices for receiving, streaming, pushing, exchanging, shuffling, intermingling, composing, influencing and/or downloading relevant said first digital contents consequent to said SPU relating descriptions and/or definitions of enterprises, owners, intended human viewers and/or users of said first digital contents attaching to said first digital contents attaching to chosen and/or selected identities of said originating devices to same, similar, analogous or approximate descriptions and definitions of enterprises, owners, intended human viewers and/or users of said active receiving devices attaching to identities of said active receiving devices attaching to second digital contents attaching to descriptions and/or definitions of enterprises, owners, intended human viewers and/or users of second digital contents;
vii. said SPU choosing and selecting said networked originating devices as active receiving devices for receiving said second digital contents attaching to descriptions and definitions of enterprises, owners, intended human viewers and/or users of said second digital contents attaching to identities of said active receiving devices by said SPU relating said descriptions and/or definitions of enterprises, owners, intended human viewers and/or users of said second digital contents to same, similar, analogous or approximate descriptions and/or definitions of enterprises, owners, intended human viewers and/or users of said originating devices for originating first digital contents;
viii. said SPU choosing and selecting said networked originating devices for originating first digital contents and passive receiving devices for receiving said first digital contents by relating descriptions and/or definitions of enterprises, owners, intended human viewers and/or users of first digital contents attaching to said digital contents attaching to SPU chosen and selected identities of said networked originating devices to same, similar, analogous or approximate descriptions and/or definitions of enterprises, owners, human viewers and/or users of passive receiving devices attaching to identities of said passive receiving devices; and
ix. said SPU choosing and selecting said networked active receiving devices for originating said second digital contents and passive receiving devices for receiving said second digital contents by relating descriptions and/or definitions of enterprises, owners, intended human viewers and/or users of second digital contents attaching to said digital contents attaching to chosen and selected identities of said networked active receiving devices to same, similar, analogous or approximate descriptions and/or definitions of enterprises, owners, human viewers and/or users of passive receiving devices attaching to identities of said passive receiving devices.

By providing said individual adaptable satellites, the present invention created said individual spheres of influence over SPU-selected, targeted and/or relevant devices constituents and enterprises, owners, human viewers and users in diverse public places and domains. Said SPU-selected digital contents are sent, received, streamed, pushed, exchanged, shuffled, intermingled, composed, influenced and downloaded to and from, by, between and/or among SPU-selected, targeted and/or relevant networked originating devices, active receiving devices and, as described supra, passive receiving devices in diverse public places and domains in individual adaptable satellites.

Said networked originating devices, active receiving devices and passive receiving devices in said one adaptable satellite comprise stationary, migrating and mobile devices for generating, sending, receiving, exchanging, shuffling, intermingling, composing, influencing and/or downloading said digital contents by, between and/or among said devices constituents; fixed display screens and mobile display screens including flat-panel displays and digital mirrors and glass for generating, sending, receiving, exchanging, shuffling, intermingling, composing, influencing and/or downloading said digital contents by, between and/or among said devices constituents; fixed groups of display screens, mobile groups of display screens including flat-panel displays and digital mirrors and glass for generating, sending, receiving, exchanging, shuffling, intermingling, composing, influencing and/or downloading said digital contents by, between and/or among said devices constituents; and said devices comprising touchscreens, cameras, infrared light sensors, facial-, fingerprint-, retinal-, voice- and speech-recognition means for machine recognizing and categorizing individuals' genders, ages, ethnicity, features, voice-activated and speech-recognition means for enabling said devices to interact with and among said devices, enterprises, owners, human viewers and users, commercially available technologies, social-networking technologies, near-field communications technologies, mobile payments technologies, facial, fingerprint, retina, speech, voice and genes recognitions and motion analysis technologies, display screen, flat-panel display, desktop, mobile device and television apps, downloads and technologic streams and pushes, codes, images and means for enabling said devices to communicate, exchange, transfer, download and shuffle information and data including electronic transactions including the transactions of domestic and global trades, commerce, businesses, transactions of domestic and global goods and services, information and data and electronic payments and transfers of payments and funds in, between and among said devices, said funds are deposited in banks and/or individual viewers' and/or users' escrow accounts in, between and among said devices; and said networked display screens and flat-panel displays including flat-panel displays and digital mirrors and glass affixed to various forms and types of surfaces being parts of and/or affixed to buildings, posts, poles and erect structures in diverse public places and domains, vehicles, means for transporting people and means for holding said display screens and flat-panel displays including flat-panel displays and digital mirrors and glass attaching to said surfaces, posts, poles in diverse public places and domains, vehicles and means for transporting people.

The present invention provides the fixed display screens and fixed groups of display screens including flat-panel displays and digital mirrors and glass in an adaptable satellite among adaptable satellites in said constellation are said display screens attached to non-mobile structures, walls, frames and surfaces of inanimate objects, structures, machines, buildings, public places and domains for people gatherings and mobile vehicles, boats, ships, airplanes in diverse communities, towns, cities, states, countries and continents, said individual display screens and flat-panel displays and digital mirrors and glass are larger—albeit any sizes, shapes and forms are provided by the present invention—than viewing screens of said servers, computers, desktops and mobile devices. Said networked display screens and groups of display screens attaching to fixed and mobile supports in diverse public locations, places, facilities and settings in diverse public places and locations for people gatherings, communities, towns, cities, states, countries and continents, said display screens, remote servers, computers and mobile devices including laptops, tablets and smartphones comprising viewing screens including touchscreens having commercially available technologies, codes, images and means for enabling said devices to communicate, exchange and shuffle information and data in, between and/or among said devices in said adaptable satellites in said constellation by cable means, wireless means, near-field communications technologies, display screen, flat-panel display, desktop, mobile device and television apps, downloads and technologic streaming and pushing.

Further to supra, the present invention provides for mobile display screens and mobile groups of display screens including flat-panel displays and digital mirrors and glass are large display screens attached to mobile structures, frames, mobile vehicles, boats, ships, airplanes, machines and animated objects in diverse public places and locations for people gatherings, communities, towns, cities, states, countries and continents, said individual display screens and flat-panel displays and digital mirrors and glass are larger than viewing screens of said servers, computers, desktops and mobile devices. Said networked display screens and groups of display screens attaching to fixed and mobile supports in diverse public locations, places facilities and settings in diverse public places and locations for people gatherings, communities, towns, cities, states, countries and continents, said display screens, remote servers, computers and mobile devices including laptops, tablets and cellular phones and smartphones comprising viewing screens including touchscreens having commercially available technologies, codes, images and means for enabling said devices to communicate, exchange and shuffle information and data in, between and/or among said devices in said adaptable satellites in said constellation by cable means, wireless means, near-field communications technologies, display screen, flat-panel display, desktop, mobile device and television apps, downloads and technologic streaming and pushing.

Said display screens and flat-panel displays having touchscreens, cameras, infrared light sensors, facial-, fingerprint-, retinal-, voice- and speech-recognition means for machine recognizing and categorizing individual viewers' and users' genders, ages, ethnicity, features, and voice-activated and speech-recognition means for enabling said devices to interact with and among said devices, enterprises, owners, human viewers and users, commercially available technologies, social-networking technologies, near-field communications technologies, mobile payments technologies, facial, fingerprint, retinal, speech, voice and genes recognitions and motion analysis technologies, display screen, flat-panel display, desktop, mobile device and television apps, downloads and technologic stream and push, QR codes, codes, images and means for enabling said devices to communicate, exchange, transfer, download and shuffle information and data including electronic transactions including the transactions of trades, commerce, businesses, transactions of domestic and global goods and services, information and data and electronic payments and transfers of payments and funds in, between and among said devices, said funds are deposited in banks and/or individual viewers' and/or users' escrow accounts in, between and among said devices.

Said networked remote servers for sending, receiving, streaming, pushing, exchanging, shuffling, intermingling, composing, influencing and/or downloading said digital contents to and from, by, between and/or among said SPU-selected devices in said networks of networked devices locating in diverse places and domains in, between and among said individual adaptable satellites, each adaptable satellite comprising variable numbers of and changeable devices constituents locating in diverse places and domains and having diverse and sphere of influence over SPU-selected, targeted and/or relevant devices constituents and enterprises, owners, human viewers and users and SPU-selected diverse public places and domains, said individual spheres of influence of said individual adaptable satellites intermingle and overlap in said constellation.

Said individual adaptable satellites to exert and project individual spheres of influence over devices constituents and selected and targeted SPU-selected and relevant enterprises, owners, human viewers and users of said devices in SPU-selected and targeted said diverse places and domains, said individual adaptable satellites to intermingle and overlap individual spheres of influence over diverse places and domains in said constellation.

Said digital contents in said networked display screens and flat-panel displays can be automatically and/or selectively caused by individual enterprises, owners, human viewers and/or users of said digital contents in said display screens and flat-panel displays into said desktops and mobile devices wherein said individual transactions of domestic and global trades, commerce, businesses, goods and services, information and data and electronic payments and transfers of payments and funds can occur in, between and among said networked devices.

Said SPU to change, exchange, adapt, assign and/or relocate devices constituents locating in diverse places and domains between and among said individual adaptable satellites.

The present invention provides a mechanism for specifying instructing SPU of said networked remote servers how to generate, send, receive, exchange, shuffle, intermingle, compose, influence and download diverse and wide spectrum of digital contents to and from, between and among SPU-selected networked originating and receiving devices constituents in said individual adaptable satellites. In other words, the present invention provides mechanisms for specifying and instructing said SPU to cause and enable any networked originating devices constituents—reciprocally, serving also as networked active receiving devices constituents—and any networked active receiving devices constituents to reciprocally serve as networked originating devices in circumstances wherein said networked devices are selected by said SPU to generate, send, receive, exchange, shuffle, intermingle, compose, influence and download different and wide spectrum of digital contents to and from, between and among SPU select networked originating and receiving devices constituents in said individual adaptable satellites whenever any said digital contents are generated and sent by any said networked devices to said servers in said constellation. Furthermore, said SPU further apply SPU-generated big data and analytics and statistics of said big data in said memories to specify and instruct servers how to send, receive, exchange, shuffle, intermingle, compose, influence and download said digital contents to and from, between and among said networked originating devices and active and passive receiving devices.

An example representing millions to billions of said occurrences, events, matters, consequences and outcomes each day in millions of locations, places and domains where billions of people live and work on the planet caused, perpetuated and sustained by said devices constituents in individual adaptable satellites in said constellation, for example, said SPU big data and analytics and statistics of said big data and mechanisms for specifying and instructing said SPU how to cause said networked servers to receive specific digital contents from an originating flat-panel display in individual communities, towns, cities, provinces and states, etc. and to send said specific digital contents via said global Web of electronic conduits to SPU-selected and targeted networked display screens and flat-panel displays in other places and domains such as, but not limited to, communities, towns, cities, provinces, states and countries on the planet wherein, furthermore, said targeted networked display screens and flat-panel displays further direct and guide said specific digital contents to and displaying said specific digital contents in targeted networked desktops, mobile devices and televisions being used and/or related to targeted enterprises, owners, human viewers and users of said specific digital contents.

Enabled by said SPU big data and analytics and statistics of said big data and mechanisms provided by the present invention, reciprocally, said representative events also include sending, receiving, streaming, pushing, exchanging, shuffling, intermingling, composing, influencing and downloading specific digital contents to and from, by, between and among said networked devices—regardless how said networked devices may be called herein—in diverse public places and domains as described in the claims of the present invention. In other words, as described above, a mechanism for enabling specific digital contents to be sent, received, exchanged, shuffled, intermingled, composed, influenced and/or downloaded from, by, between and/or among said networked devices.

An example of an adaptable satellite (a metaphor) having a sphere of influence over SPU-selected, targeted and relevant devices constituents and enterprises in diverse locations, places and domains on the planet, a Yak herder has 500 kilograms of Yak cheese for 3 Yuans per kilogram in Tibet. According to a preferred embodiments of the present invention, for example, this herder can use a networked flat-panel display or the like having a touchscreen and processor unit—said so-called networked originating flat-panel displays—affixed to the wall in a Tibet town hall in his commune—and/or use his desktop, mobile devices or television enabled by said technologies, for example, to enter and submit individual images, individual images of individual compositions of images, videos, audio, voice and/or digital data on his produce. Said submission is received by remote servers comprising SPU in Beijing and New York which are enabled by said SPU big data and analytics and statistics of said big data and mechanisms to automatically—by machine intelligence as enabled by said mechanisms and SPU-generated big data and analytics and statistics of said big data—and instantly send, stream or push said specific digital contents via said global Web of electronic conduits to SPU-selected, targeted and relevant networked display screens and flat-panel displays—said so-called networked active receiving devices such as, but not limited to, SPU-selected networked display screens and flat-panel displays and SPU-selected networked desktops, mobile devices and televisions collectively known as networked originating devices, active receiving devices and passive receiving devices in an adaptable satellite comprising hundreds, thousands or millions of said active receiving devices and passive receiving devices selected by said SPU based on the SPU-generated big data and analytics and statistics of said big data—a machine intelligence—in other places and domains such as, but not limited to, SPU-selected, targeted and relevant restaurants, super-markets, cheese factories, public transportation stations and any enterprises and people, etc., in said SPU big data and analytics and statistics of said big data in SPU-selected, targeted and relevant communities, towns, cities, provinces, states and countries in, for example, Asia, Europe, North and South America.

Enabled by said SPU big data and analytics and statistics of said big data and mechanisms provided by the present invention, said submitted individual images, individual images of individual compositions of images, videos, audio, voice and/or digital data are received, shuffled, intermingled, composed with other digital contents as adaptable compositions of said digital contents in, between and among said active receiving devices and passive receiving devices—which continue to receive other sent, streamed and/or pushed digital contents from other networked originating devices and networked active receiving devices—regardless how said networked devices may be called herein—from diverse places and domains on the planet in said adaptable satellite.

Furthermore, said networked devices, enabled by said SPU-generated big data and analytics and statistics of said big data and mechanisms automatically send, stream or push said specific digital contents to said so-called networked passive receiving devices in other places and domains such as, but not limited to, stores, shops, restaurants, super-markets, public transportation stations, etc., in communities, towns, cities, provinces, states and countries on the planet. Caused by said SPU-generated big data and analytics and statistics of said big data and mechanisms, in and among said targeted so-called networked active receiving devices, said digital contents on said herder's produce are exchanged, shuffled, intermingled and composed with other digital contents from other networked originating devices constituents in said adaptable satellite.

Yet furthermore, said targeted networked receiving display screens and flat-panel displays further direct and guide said specific digital contents to and displaying said specific digital contents in targeted networked desktops, mobile devices and televisions—said so-called networked active and passive receiving devices—being used and/or related to targeted enterprises, owners, human viewers and users of said specific digital contents as determined by said machine intelligence wherein said SPU applying said SPU big data and analytics and statistics of said big data for said networked receiving display screens and flat-panel displays to target said targeted networked desktops, mobile devices and televisions.

Further to supra, said one targeted networked receiving display screen or flat-panel display and a plurality of said networked receiving display screens and flat-panel displays—said so-called networked active receiving display screen or flat-panel display or display screens and flat-panel displays—in said adaptable satellite enabled by said machine intelligence applying said SPU-generated big data and analytics and statistics of said big data and mechanisms provided by the present invention—automatically and reciprocally sent, streamed or pushed specific digital contents such as, but not limited to, Visit Colonial Virginia, American Colleges and Skiing in Val digital contents to said networked display screen—said so-called networked originating device—affixed to said wall in said Tibet town hall in said commune and similarly SPU-selected networked active and passive receiving display screens and flat-panel displays in other places and domains such as, but not limited to, stores, shops, restaurants, super-markets, public transportation stations, etc., in communities, towns, cities, provinces, states and countries on the planet.

Enabled by said SPU big data and analytics and statistics of said big data and mechanisms provided by the present invention, said submitted individual images, individual images of individual compositions of images, videos, audio, voice and/or digital data are received, shuffled, intermingled, composed with other digital contents as adaptable compositions of said digital contents in, between and among said active receiving devices and passive receiving devices—which continue to receive other sent, streamed and/or pushed digital contents from other networked originating devices and networked active receiving devices—regardless how said networked devices may be called herein—from diverse places and domains on the planet in said adaptable satellite.

Further to supra, said targeted networked receiving display screens and flat-panel displays further direct and guide said specific digital contents to and displaying said specific digital contents in targeted networked desktops, mobile devices and televisions—said so-called networked active and passive receiving devices—being used and/or related to targeted enterprises, owners, human viewers and users of said specific digital contents as determined by said machine intelligence wherein said SPU applying said SPU big data and analytics and statistics of said big data for said networked receiving display screens and flat-panel displays to target said targeted networked desktops, mobile devices and televisions.

Yet another example of yet another adaptable satellite (a metaphor) having a different sphere of influence from supra over SPU-selected, targeted and relevant devices constituents and enterprises in diverse locations, places and domains on the planet, said Yak herder having seen said Visit Colonial Virginia digital contents in his smartphone networked to said screen in said Tibet town hall and attended and graduated from an American business school and sell airplanes. He is able to use his flat-panel display affixed to the wall in his airplane enterprise and using its touchscreen and/or desktop, mobile devices or television enabled by said technologies, for example, to enter and submit said digital contents on his aircrafts. Said submission is received by said SPU, say in U.S.A. and Europe, which is enabled by said SPU big data and analytics and statistics of said big data and mechanisms to automatically—by machine intelligence as enabled by said mechanisms and SPU-generated big data and analytics and statistics of said big data—and instantly send, stream or push said specific digital contents via said global Web of electronic conduits to SPU-selected, targeted and relevant networked display screens and flat-panel displays—said so-called networked active receiving devices—in other places and domains such as, but not limited to, SPU-selected, targeted and relevant CEO's, presidents and chairmen of companies and corporations, airlines and any enterprises and people, etc., in said SPU big data and analytics and statistics of said big data in SPU-selected, targeted and relevant communities, towns, cities, provinces, states and countries in Europe, America, South America, Canada, China, Russia, for example, wherein, furthermore, said targeted networked display screens and flat-panel displays further direct and guide said specific digital contents to and displaying said specific digital contents in targeted networked desktops, mobile devices and televisions—said so-called networked active receiving devices—being used and/or related to targeted enterprises, owners, human viewers and users of said specific digital contents. Furthermore, said networked devices, enabled by said SPU-generated big data and analytics and statistics of said big data and mechanisms automatically send, stream or push said specific digital contents to said so-called networked passive receiving devices in other places and domains such as, but not limited to, public transportation stations, etc., in communities, towns, cities, provinces, states and countries on the planet. Caused by said SPU-generated big data and analytics and statistics of said big data and mechanisms, in and among said targeted so-called networked active receiving devices, said digital contents on said herder's produce are exchanged, shuffled, intermingled and composed with other digital contents from other networked originating devices constituents in another adaptable satellite different from supra.

Said SPU applying said SPU-generated big data and analytics and statistics of said big data to effect said networked servers to send, receive, stream, push, exchange, shuffle, intermingle and compose said digital contents to and from, by, between and among said devices constituents in diverse places and domains in said individual adaptable satellites to generate and to overlap said spheres of influence of said adaptable satellites in said constellation. Said SPU applying said SPU-generated big data and analytics and statistics of said big data to choose and select networked originating devices, active receiving devices and passive receiving devices for sending, receiving, streaming, pushing, exchanging, shuffling, intermingling, composing, influencing and/or downloading relevant digital contents to and from, by, between and/or among said networked devices in said individual adaptable satellites. Consequently, moving or mobilizing stationary and mobile computers and mobile devices in individual adaptable satellites in, between and among diverse places and domains on the planet. Moving or mobilizing mobile display screens including flat-panel displays and digital mirrors and glass in individual adaptable satellites attaching to mobile supports in diverse public locations, places, facilities and settings in, between and among diverse places, locations, communities, towns, cities, states, countries and continents. Moving or mobilizing mobile display screens including flat-panel displays and digital mirrors and glass in individual adaptable satellites attaching to fixed and mobile supports attaching to mobile structures, frames, mobile vehicles, trains, boats, ships, airplanes, machines, inanimate structures and objects and animated objects in, between and among diverse communities, towns, cities, states, countries and continents.

Further to supra, said millions or billions of networked desktops, mobile devices and televisions—enabled by said machine intelligence, remote servers and said technologies including, but not limited to, near-field communications influence and adapt said digital contents of, between and among said networked originating devices, active receiving devices and passive receiving devices in, between and among individual adaptable satellites in said constellation.

Furthermore, said networked display screens and flat-panel displays cause said desktops, mobile devices and televisions to send, stream and push digital contents to remote display screens and flat-panel displays in diverse locations and domains.

Yet furthermore, said SPU applying changes or adaptations submitted by said networked devices constituents to adapt and grow said SPU-generated big data and analytics and statistics of said big data to adapt, assign and/or relocate individual SPU-selected networked devices constituents to and from, between and among individual adaptable satellites in said constellation of adaptable satellites;

Thus, said simplified examples describe the claims of the invention infra and represent millions to billions of said occurrences, events, matters, consequences and outcomes each day in places and domains on the planet.

Therefore, according to the spirit and the scope of the claims of the present invention, the present invention provides for as many individual adaptable satellites as said SPU-generated big data and analytics and statistics of said big data and said mechanisms will create. Furthermore, said SPU-generated big data and analytics and statistics of said big data and said mechanisms provide said networked devices for sending, receiving, streaming, pushing, exchanging, shuffling, intermingling, composing, influencing and/or downloading by, between and/or among said networked devices regardless of how said networked devices may be called herein and also between and among individual adaptable satellites in said constellation.

Furthermore, one of the preferred embodiments of the present invention, said SPU applying changes or adaptation submitted by said devices to change or adapt said SPU-generated big data and analytics and statistics of said big data to adapt, assign and/or relocate devices in individual adaptable satellites to, between and/or among individual adaptable satellites to adapt said individual spheres of influence. Said SPU applying changes or adaptation submitted by said devices to change or adapt said SPU-generated big data and analytics and statistics of said big data to adapt, assign and/or relocate devices in individual adaptable satellites to, between and/or among individual adaptable satellites to adapt said individual spheres of influence. In other words, said SPU applying said SPU-generated big data and analytics and statistics of said big data to constitute and adapt said originating devices and receiving devices constituents in, between and among individual adaptable satellites to expedite and enhance trades, commerce, businesses and/or services by and among said devices constituents and SPU-selected and targeted enterprises, owners, human viewers and/or users of said devices constituents in diverse places and domains. One of the preferred embodiments, said SPU attaching identities of individual devices attaching to same, similar, analogous or approximate descriptions and/or definitions of enterprises, owners, human viewers and/or users to an adaptable satellite comprising said devices attaching to same, similar, analogous or approximate descriptions and/or definitions of enterprises, owners, human viewers and/or users in said networked servers wherein said descriptions and/or definitions attaching to identities of said devices, descriptions and/or definitions of viewers and/or users and/or digital contents in said memories are adapted, updated and/or differed from previous individual versions of descriptions, definitions, digital contents by said SPU receiving individual adaptations, updates and/or changes in said descriptions, definitions, digital contents from said devices in said adaptable satellites in said constellation.

Based on millions to billions of said occurrences, events, matters, consequences and outcomes each day in diverse places and domains on the planet, the present invention creates, grows, sustains and adapts said machine intelligence and SPU big data and analytics and statistics of said big data and, consequently, the Global Super Store wherein any and all said networked devices from any and all places and domains on the planet being used by millions to billions of enterprises and people such as, but not limited to, companies, corporations, businesses, manufacturers, retailers, merchants, employers, stores and employees, staff, consultants and billions of people including targeted enterprises and targeted consumers using said screens and displays, desktops, mobile devices and televisions for generating, sending, receiving, exchanging, shuffling, intermingling, composing, influencing and/or downloading said digital contents by, between and/or among said devices constituents in said constellation of said adaptable satellites. The present invention provides cloud computing for said constellation of said adaptable satellites to generate and sustain a global Web of electronic conduits for causing specific digital contents to be generated, sent, received, exchanged, shuffled, intermingled, composed, influenced and/or downloaded by, between and/or among targeted networked devices being used by billions of targeted enterprises and people to achieve the goals and objectives of the present invention.

Consequently, one of the preferred embodiments of the present invention as represented by the claims infra including technologies identified herein and their derivatives caused the present invention to be endowed with machine intelligence created by massive enterprises', owners', human viewers' and users' inputs, adaptations of inputs and possibilities from which machine learning caused the present invention to be a cloud computing-automated Global Super Store capable of functioning and achieving the objectives for continually serving billions of said networked devices, enterprises and people far more than and above and beyond any and all human brains and engagements are capable of achieving.

One of the preferred embodiments of the present invention applicable to billions of enterprises and people provides for said remote cloud computing servers networked to and supporting millions to billions of said networked devices, enterprises and people to accept and take any and all digital contents generated and submitted by millions to billions of said networked devices per unit time and machine-intelligently process and analyze said submitted diverse and wide spectrum of digital including elements and details of said submitted digital contents from said screens, displays, desktops, mobile devices and television to grow SPU-generated big data and analytics and statistics of said big data in said memories of said cloud computing servers to generate, send, receive, exchange, shuffle, intermingle, compose, influence and download said diverse and wide spectrum of digital contents to and from, between and among SPU-selected networked originating and receiving devices constituents in said individual adaptable satellites.

Said autonomous system and method machine-intelligently processing and analyzing and applying said submitted digital contents including elements and details of said submitted digital contents in said networks of said networked devices to achieve the goals and objectives of the present invention. Said achievements are assisted by said SPU applying said SPU-generated big data and analytics and statistics of said big data and their derivatives. Therefore, it is obvious to that said technologies and SPU-generated big data and analytics and statistics of said big data and their derivatives, one of the preferred embodiments represented in the claims of the present invention is said inevitable and eventual autonomous machine-intelligent system and method with far more insights and decision-making capability superseding those of and superior, unavailable and unknown to said individual and groups of enterprises, owners, producers, viewers and users—and any combination thereof—of said digital contents in said networks.

Said autonomous system and method machine-intelligently directing and guiding millions to billions of enterprises, owners, human viewers and users of said SPU-selected networked devices attaching to specific and detailed digital contents on and related to said enterprises, owners, human viewers and users of said networked devices in said networks of said networked devices in any and all places and domains on the planet. Said cloud computing servers apply said SPU-generated big data and analytics and statistics of said big data to machine-intelligently enable, effect, direct. guide. expedite and enhance domestic and global commerce, trades, businesses and transactions of goods and services for millions of enterprises and people in individual nations and billions of enterprises and people on the planet.

For example, an image submitted to said remote servers for cloud computing by a networked device networked to said networked devices and remote servers. In said remote server or servers, said submitted image can be adapted, edited and improved by said machine-intelligent SPU applying said SPU-generated big data and analytics and statistics of said big data so that the adapted, edited and/or improved submitted image optimally serves any and all enterprises, owners, viewers and users of said image which are sent, streamed or pushed to relevant networked devices constituents wherein said sent, streamed or pushed image is effectively or optimally and automatically intermingled, composed and integrated with digital contents present in said relevant networked devices.

Said example is applicable to any and all digital contents in any and all settings, circumstances, places and domains described in the preferred embodiments to achieve the goals and objectives of the present invention.

Furthermore, because of said autonomous machine-intelligent system and method—endowed by said SPU-generated big data and analytics and statistics of said big data and machine learning technologies—with far more and better insights and foresight and smarter decision-making capability than those of said enterprises, owners, viewers and users of said digital contents on the planet, said events and phenomena are achieved and present in said relevant networked device enormously more rapidly, if not most rapidly, than any and all processes heretofore available any and all enterprises, producers, owners, viewers and users. In fact, said SPU-generated big data and analytics and statistics of said big data and machine learning technologies for creating said an autonomous machine-intelligent system and method which are more superior than any and all systems and methods being used by any and all enterprises, producers, owners, viewers and users. said big data and analytics and statistics of said big data for causing said SPU of said remote servers to analyze said big data and analytics and statistics of said big data, and

Said big data and analytics and statistics of said big data for causing said SPU in said remote servers how to repeatedly and predictably or reliably i.constitute and adapt individual networked devices constituents in individual adaptable satellites and between and among said individual adaptable satellites; send, receive, exchange, shuffle, intermingle, compose, influence and download said diverse and wide spectrum of digital contents to and from, by, between and among SPU-selected networked devices; and iii. direct, guide, expedite and enhance domestic and global trades, commerce, businesses and transactions of goods and services. Furthermore, as one of the preferred embodiments, said autonomous system and method machine-intelligently and automatically create and effect said events and phenomena and create outcomes on the planet without any interventions of enterprises and people.

Although the present invention provides for networked display screens and flat-panel displays, digital mirrors and glass affixed to surfaces of diverse public places and domains, it is to be understood that said networked display screens and flat-panel displays also implied said digital mirrors and glass.

Although various preferred embodiments of how SPU-generated big data and analytics and statistics of said big data and their applications to create machine intelligence for achieving the goals and objectives of the present invention have been described, it will be appreciated by those skilled in the art that adaptations, variations and derivatives are and will be made to and achieved for said SPU-generated big data and analytics and statistics of said big data without departing from the spirit and the scope of the claims of the present invention.

Although various preferred embodiments of the present invention have been described, it will be appreciated by those skilled in the art that adaptations, variations and derivatives are and will be made and achieved without departing from the spirit and the scope of the claims of the present invention.

1. A system of networked display screens and flat-panel displays for generating, sending, receiving, streaming, pushing, exchanging, shuffling, intermingling, composing, influencing and downloading images, individual images of individual compositions of images, videos, audio, voice and digital data henceforth digital contents to and from, between and among servers-processor units (henceforth SPU) selected networked display screens and flat-panel displays affixed to surfaces of diverse public places and domains and networked to said SPU of remote servers in networks of said display screens and flat-panel displays, said SPU-selected networked display screens and flat-panel displays and SPU-selected networked desktops, mobile devices and televisions henceforth networked originating devices, active receiving devices and passive receiving devices in individual adaptable satellites wherein individual networked originating devices for specifying and instructing said SPU how to select relevant networked active and passive receiving devices and individual said networked active receiving devices for specifying and instructing said SPU how to select relevant networked active receiving devices including said individual networked originating devices and passive receiving devices in an adaptable satellite in networks of networked devices in a constellation of individual adaptable satellites, said networks of display screens and flat-panel displays for expediting and enhancing trades, commerce, businesses and transactions of goods and services between and among said SPU-selected and networked originating devices for targeting said networked devices, said system comprising:
said networks of networked originating devices, active receiving devices and passive receiving devices and remote servers comprising cable and wireless networking capabilities, near-field communications and social-networking technologies, said remote servers comprising cloud-computing technologies, said networked devices and servers comprising processors units coupled to memories;
said SPU for selecting relevant networked originating devices and receiving devices constituents in an adaptable satellites;
said remote servers for generating, sending, receiving, streaming, pushing, exchanging, shuffling, intermingling, composing, influencing and downloading said digital contents to and from, between and among SPU-selected networked devices in diverse public places and domains;
said digital contents for directing, guiding, expediting and enhancing domestic and global trades, commerce, businesses and transactions of goods and services;
networked originating display screens and flat-panel displays for generating, sending, receiving, exchanging, shuffling, intermingling, composing, influencing and downloading digital contents to and from, between and among said SPU-selected and relevant networked originating and active and passive receiving display screens and flat-panel displays, said networked originating display screens and flat-panel displays for specifying and instructing said SPU how to select relevant networked originating devices, active receiving devices and passive receiving devices for generating, sending, receiving, exchanging, shuffling, intermingling, composing, influencing and downloading digital contents to and from, between and among said networked devices in individual adaptable satellites;
said networked desktops, mobile devices and televisions for influencing and adapting said digital contents of, between and among said networked devices;
said networked display screens and flat-panel displays for causing said networked desktops, mobile devices and televisions to send, stream and push digital contents to remote display screens and flat-panel displays;
SPU-generated big data and analytics and statistics of said big data for specifying and instructing said SPU in said remote servers how to select, constitute and adapt individual networked devices constituents in individual adaptable satellites and between and among said individual adaptable satellites in said networks of networked devices;
said big data and analytics and statistics of said big data for specifying and instructing said SPU in said remote servers how to send, receive, exchange, shuffle, intermingle, compose, influence and download said diverse and wide spectrum of digital contents to and from, by, between and among SPU-selected networked devices;
said big data and analytics and statistics of said big data for specifying and instructing said SPU in said remote servers how to direct, guide, expedite and enhance domestic and international domestic and global trades, commerce, businesses and transactions of goods and services;
said SPU-generated big data and said big data and analytics and statistics of said big data for said SPU:
i. selecting, constituting, creating, maintaining and adapting said SPU-selected networked devices constituents for generating, sending, receiving, streaming, pushing, exchanging, shuffling, intermingling, composing, influencing and downloading SPU-selected digital contents to and from, between and among SPU-selected networked devices in individual adaptable satellites;
ii. selecting and constituting SPU-selected networked desktops, mobile devices and televisions in individual adaptable satellites;
iii. adapting, assigning and/or relocating individual SPU-selected networked devices constituents of, between and among individual adaptable satellites in said constellation of adaptable satellites; and
iv. generating, maintaining, adapting, sending, receiving, exchanging, shuffling, intermingling, composing, influencing and downloading said SPU-selected digital contents to and from, between and among said networked devices in individual adaptable satellites;
said big data and analytics and statistics of said big data for causing said SPU of said remote servers to analyze said big data and analytics and statistics of said big data, and said big data and analytics and statistics of said big data for causing said SPU in said remote servers how to repeatedly and predictably or reliably:
i. constitute and adapt individual networked devices constituents in individual adaptable satellites and between and among said individual adaptable satellites;
ii. send, receive, exchange, shuffle, intermingle, compose, influence and download said diverse and wide spectrum of digital contents to and from, by, between and among SPU-selected networked devices;
iii. direct, guide, expedite and enhance domestic and global trades, commerce, businesses and transactions of goods and services;
attaching to said SPU:
i. a mechanism for said big data and analytics and statistics of said big data for specifying and instructing said SPU how to attach individual identities of said devices constituents to descriptions and definitions of enterprises, owners, intended human viewers and/or users of said devices and how to attach said individual identities of said devices constituents to digital contents, how to attach said digital contents to descriptions and definitions of enterprises, owners, intended human viewers and/or users of said digital contents;
ii. a mechanism for said big data and analytics and statistics of said big data and analytics and statistics of said big data for specifying and instructing said SPU how to generate, grow and adapt said SPU-generated big data and analytics of said big data;
iii. a mechanism for said big data and analytics and statistics of said big data for specifying and instructing said SPU how to apply said SPU-generated big data, analytics and statistics how to constitute and adapt said networked originating devices and receiving devices for generating, sending, receiving, streaming, pushing, exchanging, shuffling, intermingling, composing, influencing and downloading digital contents to and from, by, between and among said SPU-selected networked devices constituents;
iv. a mechanism for said big data and analytics and statistics of said big data, analytics and statistics for specifying and instructing said SPU how to apply said SPU-generated big data to constitute said networked devices constituents for sending, receiving, streaming, pushing, exchanging, shuffling, intermingling, composing, influencing and/or downloading said digital contents to and from, by, between and among said networked devices constituents;
v. a mechanism for said big data and analytics and statistics of said big data, analytics and statistics for specifying and instructing said SPU how to apply said SPU-generated big data to constitute said networked originating display screens and flat-panel displays for generating, sending, receiving, exchanging, shuffling, intermingling, composing, influencing and downloading digital contents to and from, between and among said SPU select relevant networked originating and receiving display screens and flat-panel displays;
vi. a mechanism for said big data and analytics and statistics of said big data, analytics and statistics for specifying and instructing said SPU how to apply said SPU-generated big data to select networked originating and receiving display screens and flat-panel displays for specifying and instructing said SPU how to select relevant networked originating devices, active receiving devices and passive receiving devices for generating, sending, receiving, exchanging, shuffling, intermingling, composing, influencing and downloading digital contents to and from, between and among said networked devices;
vii. a mechanism for said big data and analytics and statistics of said big data, analytics and statistics for specifying and instructing said SPU how to cause said servers to send, receive, stream, push, exchange, shuffle, intermingle, compose, influence and download said digital contents to and from, between and among said networked devices in said individual adaptable satellites in diverse public places and domains;
viii. a mechanism for said big data and analytics and statistics of said big data, analytics and statistics for specifying and instructing said SPU how to cause said remote servers to generate, send, receive, stream, push, exchange, shuffle, intermingle, compose, influence and download digital contents to and from, between and among SPU select relevant networked originating devices, active receiving devices and passive receiving devices;
ix. a mechanism for said big data and analytics and statistics of said big data, analytics and statistics for specifying and instructing said SPU how to deselect selected devices constituents;
x. a mechanism for said big data and analytics and statistics of said big data, analytics and statistics for specifying and instructing said SPU how to adapt, assigning and/or relocating individual devices constituents of, between and among individual adaptable satellites in said constellation of adaptable satellites to adapt and change individual spheres of influence;
xi. a mechanism for said big data and analytics and statistics of said big data, analytics and statistics for specifying and instructing said SPU how to analyze, adapt, improve and grow and said remote servers how to learn from said SPU-generated and analytics from submissions and adaptations generated and submitted by said networked devices constituents in said individual adaptable satellites and changing devices constituents;
xii. a mechanism for said big data and analytics and statistics of said big data, analytics and statistics for specifying and instructing said SPU how to learn how to analyze, adapt, improve and grow and said remote servers how to learn from said SPU-generated big data and analytics from continual inputs of said data from said networked devices to said SPU and into memories and how to apply said SPU-generated big data to automatically operate, sustain, support, grow and perpetuate said system, method, processes and outcomes generated by, between and among said networked devices;
xiii. a mechanism for specifying and instructing said processor units in said desktops, mobile devices and television how to influence and adapt digital contents in display screens and flat-panel displays;
xiv. a mechanism for said big data and analytics and statistics of said big data, analytics and statistics for specifying and instructing said processor units how to apply said SPU-generated big data, analytics and statistics to cause digital contents in display screens and flat-panel displays to be downloaded to and displayed in said SPU-selected desktops, mobile devices and televisions;
a constellation of individual adaptable satellites with overlapping individual spheres of influence in diverse places and domains.

2. The system according to claim 1 wherein said individual adaptable satellites comprising variable numbers of and changeable SPU-selected networked originating devices, active receiving devices and passive receiving devices constituents locating in diverse places and domains and having diverse and sphere of influence over SPU-selected networked devices constituents and enterprises, owners, human viewers and users of said networked devices constituents.

3. The system according to claim 1 wherein said networked originating devices are networked active receiving devices and, reciprocally, said networked active receiving devices are networked originating devices, said networked devices for sending, receiving, streaming, pushing, exchanging, shuffling, intermingling, composing, influencing and downloading digital contents to and from, by, between and/or among said SPU-selected networked devices in said individual adaptable satellites.

4. The system according to claim 1 wherein said individual networked originating devices for specifying and instructing said SPU how to select relevant networked active and passive receiving devices and individual said networked active receiving devices for specifying and instructing said SPU how to select relevant networked active receiving devices including said individual networked originating devices and passive receiving devices in an adaptable satellite comprise:
i. said individual networked originating devices for generating and submitting to said SPU individual identities of said networked originating devices, individual descriptions and definitions of enterprises, owners, human viewers and/or users of said individual networked originating devices, digital contents in said individual networked originating devices, and individual descriptions and definitions of intended enterprises, owners, human viewers and/or users of said digital contents in said networked receiving devices;
ii. said individual networked active receiving devices for generating and submitting to said SPU individual identities of said networked active receiving devices, individual descriptions and definitions of enterprises, owners, human viewers and/or users of said individual networked active receiving devices, digital contents in said individual networked active receiving devices, and individual descriptions and definitions of enterprises, owners, intended human viewers and/or users of said digital contents in said networked active receiving devices including said networked originating devices and passive receiving devices; and
iii. said individual networked passive receiving devices for generating and submitting to said SPU individual identities of said networked passive receiving devices, individual descriptions and definitions of enterprises, owners, human viewers and/or users of said individual networked passive receiving devices.

5. The system according to claim 1 wherein said networked originating devices, active receiving devices and passive receiving devices in said individual adaptable satellites are:
fixed display screens and mobile display screens including flat-panel displays and digital mirrors and glass for generating, sending, receiving, exchanging, shuffling, intermingling, composing, influencing and/or downloading said digital contents to and from, by, between and/or among said networked devices constituents;
fixed groups of display screens, mobile groups of display screens including flat-panel displays and digital mirrors and glass for generating, sending, receiving, exchanging, shuffling, intermingling, composing, influencing and/or downloading said digital contents to and from, by, between and/or among said networked devices constituents; and
said networked display screens and flat-panel displays including flat-panel displays and digital mirrors and glass affixed to various forms and types of surfaces being parts of and/or affixed to buildings, posts, poles and erect structures in diverse public places and domains, vehicles, means for transporting people and means for holding said display screens and flat-panel displays including flat-panel displays and digital mirrors and glass attaching to said surfaces, posts, poles in diverse public places and domains, vehicles and means for transporting people;
said networked stationary and/or migrating desktops and televisions and mobile devices for influencing and adapting said digital contents of, between and among said networked devices;
said networked stationary and/or migrating desktops and televisions and mobile devices for generating, sending, receiving, exchanging, shuffling, intermingling, composing, influencing and/or downloading said digital contents to and from, by, between and/or among said networked originating devices, active receiving devices and passive receiving devices.

6. The system according to claim 1 wherein said SPU-generated big data comprising:
i. relations comprising identities of individual networked originating devices, identities of individual active receiving devices and identities of individual passive receiving devices, descriptions and definitions of individual enterprises, owners, intended human viewers and/or users of said individual networked devices, individual digital contents and descriptions and definitions of enterprises, owners, intended human viewers and/or users of said digital contents;
ii. data on enterprises, owners, intended human viewers and users of said networked display screens and flat-panel displays generated by individual networked originating devices, identities of individual active receiving devices;
iii. relations of individual descriptions and definitions of enterprises, owners, human viewers and/or users, individual identities of networked originating devices using said originating devices, said individual identities of networked originating devices, individual digital contents and attaching said individual digital contents and individual descriptions and definitions of enterprises, owners, human viewers and/or users said individual digital contents;
iv. relations of individual descriptions and definitions of enterprises, owners, human viewers and/or users to individual identities of networked active receiving devices using said originating devices, said individual identities of networked active receiving devices, individual digital contents and attaching said individual digital contents and individual descriptions and definitions of enterprises, owners, human viewers and/or users of said individual digital contents;
v. relations of individual descriptions and definitions of enterprises, owners, human viewers and/or users and individual identities of networked passive receiving devices using said passive receiving devices;
vi. relations of individual identities of said networked devices having attached same, similar or equivalent individual descriptions and definitions of enterprises, owners, human viewers and/or users of individual digital contents and said individual digital contents having said attached same, similar or equivalent individual description;
vii. relations of individual identities of said networked devices having attached same, similar or equivalent individual descriptions and definitions of enterprises, owners, human viewers and/or users of individual elements of individual components of individual digital contents and attaching said individual elements of individual components of individual digital contents having said attached same, similar or equivalent individual descriptions and definitions of enterprises, owners, human viewers and/or users to said attached networked devices;
viii. said SPU for analyzing, adapting, improving and growing and learning from said SPU-generated big data in said cloud computing servers in said memories.

7. The system according to claim 1 wherein said individual spheres of influence over SPU-selected devices constituents and enterprises, owners, human viewers and users in diverse public places and domains are SPU-selected digital contents attaching to said SPU-selected identities of devices constituents and enterprises, owners, human viewers and users and SPU-selected diverse public places and domains, said SPU-selected digital contents are sent, received, streamed, pushed, exchanged, shuffled, intermingled, composed, influenced and downloaded to, by, between and/or among SPU-selected devices constituents in diverse public places and domains in individual adaptable satellites.

8. In a system of networked display screens and flat-panel displays for generating, sending, receiving, streaming, pushing, exchanging, shuffling, intermingling, composing, influencing and downloading images, individual images of individual compositions of images, videos, audio, voice and digital data henceforth digital contents to and from, between and among servers-processor units (henceforth SPU) selected networked display screens and flat-panel displays affixed to surfaces of diverse public places and domains and networked to said SPU of remote servers in networks of said display screens and flat-panel displays, said networked display screens and flat-panel displays for specifying and instructing SPU of networked remote servers how to select relevant said networked display screens and flat-panel displays for generating, sending, receiving, exchanging, shuffling, intermingling, composing, influencing and downloading said digital contents to and from, between and among said SPU-selected networked display screens and flat-panel displays in networks of said networked devices, said SPU-selected networked display screens and flat-panel displays and SPU-selected networked desktops, mobile devices and televisions henceforth networked originating devices, active receiving devices and passive receiving devices in individual adaptable satellites wherein individual networked originating devices for specifying and instructing said SPU how to select relevant networked active and passive receiving devices and individual said networked active receiving devices for specifying and instructing said SPU how to select relevant networked active receiving devices including said individual networked originating devices and passive receiving devices in an adaptable satellite in networks of networked devices in a constellation of individual adaptable satellites, a method for SPU-selected networked devices constituents in individual adaptable satellites to generate, send, receive, stream, push, exchange, shuffle, intermingle, compose, influence and download digital contents to and from, between and among said SPU-selected networked devices constituents and to constitute and adapt said originating devices and receiving devices constituents in, between and among individual adaptable satellites to expedite and enhance domestic and global trades, commerce, businesses and transactions of goods and services, said method comprising processes for:
networking said adaptable satellites and servers comprising near-field communications, cable and wireless technologies and cloud-computing technologies, said adaptable satellites and servers comprising cable and wireless networking capabilities and near-field communications technologies, processors units coupled to memories;
attaching said networked display screens and groups of display screens including flat-panel displays and digital mirrors and glass to fixed and mobile supports in diverse public locations, places and settings in diverse communities, towns, cities, states, countries and continents;
said SPU to select relevant networked originating devices and receiving devices constituents in individual adaptable satellites from SPU-generated big data and analytics and statistics in said memories;
attaching to said SPU:
i. a mechanism for said big data and analytics and statistics of said big data for specifying and instructing said SPU how to attach individual identities of said devices constituents to descriptions and definitions of enterprises, owners, intended human viewers and/or users of said devices and how to attach said individual identities of said devices constituents to digital contents, how to attach said digital contents to descriptions and definitions of enterprises, owners, intended human viewers and/or users of said digital contents;
ii. a mechanism for said big data and analytics and statistics of said big data and analytics and statistics of said big data for specifying and instructing said SPU how to generate, grow and adapt said SPU-generated big data and analytics of said big data;
iii. a mechanism for said big data and analytics and statistics of said big data for specifying and instructing said SPU how to apply said SPU-generated big data, analytics and statistics how to constitute and adapt said networked originating devices and receiving devices for generating, sending, receiving, streaming, pushing, exchanging, shuffling, intermingling, composing, influencing and downloading digital contents to and from, by, between and among said SPU-selected networked devices constituents;
iv. a mechanism for said big data and analytics and statistics of said big data, analytics and statistics for specifying and instructing said SPU how to apply said SPU-generated big data to constitute said networked devices constituents for sending, receiving, streaming, pushing, exchanging, shuffling, intermingling, composing, influencing and/or downloading said digital contents to and from, by, between and among said networked devices constituents;
v. a mechanism for said big data and analytics and statistics of said big data, analytics and statistics for specifying and instructing said SPU how to apply said SPU-generated big data to constitute said networked originating display screens and flat-panel displays for generating, sending, receiving, exchanging, shuffling, intermingling, composing, influencing and downloading digital contents to and from, between and among said SPU select relevant networked originating and receiving display screens and flat-panel displays;
vi. a mechanism for said big data and analytics and statistics of said big data, analytics and statistics for specifying and instructing said SPU how to apply said SPU-generated big data to select networked originating and receiving display screens and flat-panel displays for specifying and instructing said SPU how to select relevant networked originating devices, active receiving devices and passive receiving devices for generating, sending, receiving, exchanging, shuffling, intermingling, composing, influencing and downloading digital contents to and from, between and among said networked devices;
vii. a mechanism for said big data and analytics and statistics of said big data, analytics and statistics for specifying and instructing said SPU how to cause said servers to send, receive, stream, push, exchange, shuffle, intermingle, compose, influence and download said digital contents to and from, between and among said networked devices in said individual adaptable satellites in diverse public places and domains;
viii. a mechanism for said big data and analytics and statistics of said big data, analytics and statistics for specifying and instructing said SPU how to cause said remote servers to generate, send, receive, stream, push, exchange, shuffle, intermingle, compose, influence and download digital contents to and from, between and among SPU select relevant networked originating devices, active receiving devices and passive receiving devices;
ix. a mechanism for said big data and analytics and statistics of said big data, analytics and statistics for specifying and instructing said SPU how to deselect selected devices constituents;
x. a mechanism for said big data and analytics and statistics of said big data, analytics and statistics for specifying and instructing said SPU how to adapt, assigning and/or relocating individual devices constituents of, between and among individual adaptable satellites in said constellation of adaptable satellites to adapt and change individual spheres of influence;
xi. a mechanism for said big data and analytics and statistics of said big data, analytics and statistics for specifying and instructing said SPU how to analyze, adapt, improve and grow and said remote servers how to learn from said SPU-generated and analytics from submissions and adaptations generated and submitted by said networked devices constituents in said individual adaptable satellites and changing devices constituents;
xii. a mechanism for said big data and analytics and statistics of said big data, analytics and statistics for specifying and instructing said SPU how to analyze, adapt, improve and grow and said remote servers how to learn from said SPU-generated big data and analytics from continual inputs of said data from said networked devices to said SPU and into memories and how to apply said SPU-generated big data to automatically operate, sustain, support, grow and perpetuate said system, method, processes and outcomes generated by, between and among said networked devices;
xiii. a mechanism for specifying and instructing said processor units in said desktops, mobile devices and television how to influence and adapt digital contents in display screens and flat-panel displays;
xiv. a mechanism for said big data and analytics and statistics of said big data, analytics and statistics for specifying and instructing said processor units how to apply said SPU-generated big data, analytics and statistics to cause digital contents in display screens and flat-panel displays to be downloaded to and displayed in said SPU-selected desktops, mobile devices and televisions;
said individual networked originating devices to generate and submit to said SPU individual identities of said networked originating devices, individual descriptions and definitions of enterprises, owners, human viewers and/or users of said individual networked originating devices, digital contents in said individual networked originating devices, and individual descriptions and definitions of enterprises, owners, intended human viewers and/or users of said digital contents in said networked receiving devices;
said individual networked active receiving devices to generate and submit to said SPU individual identities of said networked active receiving devices, individual descriptions and definitions of enterprises, owners, intended human viewers and/or users of said networked active receiving devices, digital contents of said individual networked active receiving devices, and individual descriptions and definitions of enterprises, owners, intended human viewers and/or users of said digital contents;
said individual networked passive receiving devices to generate and submit to said SPU individual identities of said networked passive receiving devices, individual descriptions and definitions of enterprises, owners, intended human viewers and/or users of said individual networked passive receiving devices;
said networked display screens and flat-panel displays, desktops, mobile devices, televisions networked to said SPU to send, receive, stream, push, exchange, shuffle, intermingle, compose, influence and download said digital contents to and from, between and among said networked devices in said individual adaptable satellites;
said networked display screens and flat-panel displays for generating, sending, streaming and pushing digital contents of said networked display screens and flat-panel displays to said SPU-selected networked devices;
said networked display screens and flat-panel displays to send, receive, stream, push, exchange, shuffle, intermingle, compose, influence and download digital contents to and from SPU-selected desktops, mobile devices and televisions;
said networked desktops, mobile devices and televisions to influence and adapt said digital contents of, between and among said networked devices;
said networked display screens and flat-panel displays to cause said desktops, mobile devices and televisions to send, stream and push digital contents to remote display screens and flat-panel displays in said individual adaptable satellites;
said SPU applying changes or adaptations submitted by said networked devices constituents to adapt, assign and/or relocate individual SPU-selected networked devices constituents of, between and among individual adaptable satellites in said constellation of adaptable satellites;
said SPU generating, growing and adapting said SPU-generated big data in said memories;
said SPU applying said SPU-generated big data to:
i. select networked display screens and flat-panel displays and networked desktops, mobile devices and televisions in individual adaptable satellites;
ii. adapt, assign and/or relocate individual SPU-selected networked devices constituents of, between and among individual adaptable satellites in said constellation of adaptable satellites;
iii. create, maintain and adapt said SPU-selected digital contents of, between and among said networked devices in individual adaptable satellites;
iv. cause said remote servers to create, maintain and adapt said SPU-selected networked devices constituents for generating, sending, receiving, streaming, pushing, exchanging, shuffling, intermingling, composing, influencing and downloading SPU-selected digital contents to and from, between and among SPU-selected networked devices in individual adaptable satellites;
said SPU for applying said big data and analytics and statistics of said big data to cause said remote servers to repeatedly and predictably or reliably:
i. constitute and adapt individual networked devices constituents in individual adaptable satellites and between and among said individual adaptable satellites;
ii. send, receive, exchange, shuffle, intermingle, compose, influence and download said diverse and wide spectrum of digital contents to and from, by, between and among SPU-selected networked devices;
iii. direct, guide, expedite and enhance domestic and global trades, commerce, businesses and transactions of goods and services;
said individual adaptable satellites projecting and exerting individual spheres of influence over devices constituents and selected and targeted SPU-selected and relevant enterprises, owners, human viewers and users of said devices in SPU-selected and targeted said diverse places and domains, said individual adaptable satellites to intermingle and overlap individual spheres of influence in said constellation;
said SPU applying said SPU-generated big data to effect said networked servers to send, receive, stream, push, exchange, shuffle, intermingle and compose said digital contents to and from, by, between and among said devices constituents in diverse places and domains in said individual adaptable satellites to generate and to overlap said spheres of influence of said adaptable satellites in said constellation.

9. The method according to claim 8 wherein said process for said SPU generating said SPU-generated big data in said memories comprises processes for said SPU:
i. attaching descriptions and definitions of individual enterprises, owners, human viewers and/or users of individual networked originating devices to identities of said individual networked originating devices, attaching identities of individual networked originating devices to individual digital contents originating in said individual networked originating devices and attaching said individual digital contents to descriptions and definitions of individual enterprises, owners, human viewers and/or users of said individual digital contents;
ii. attaching descriptions and definitions of individual enterprises, owners, human viewers and/or users of individual networked active receiving devices to identities of said individual networked active receiving devices, attaching identities of individual networked active receiving devices to individual digital contents originating in said individual networked active receiving devices and attaching said individual digital contents to descriptions and definitions of individual enterprises, owners, human viewers and/or users of said individual digital contents;
iii. attaching descriptions and definitions of individual enterprises, owners, human viewers and/or users of individual networked passive receiving devices to identities of individual networked passive receiving devices;
iv. attaching individual identities of networked originating devices attaching to individual digital contents to individual identities of networked active receiving devices having attached same, similar or equivalent individual descriptions and definitions of enterprises, owners, human viewers and/or users of said individual digital contents and attaching said individual digital contents having said attached same, similar or equivalent individual descriptions and definitions of human viewers and/or users of said individual digital contents to said networked devices;
v. attaching individual identities of networked originating devices attaching to individual digital contents to individual identities of networked active receiving devices having attached same, similar or equivalent individual descriptions and definitions of enterprises, owners, human viewers and/or users of individual components of said individual digital contents and attaching said individual digital contents having said attached same, similar or equivalent individual descriptions and definitions of enterprises, owners, human viewers and/or users of said individual components of to said networked devices;
vi. attaching individual identities of networked originating devices attaching to individual digital contents to individual identities of networked active receiving devices having attached same, similar or equivalent individual descriptions and definitions of enterprises, owners, human viewers and/or users of individual components of said individual digital contents and attaching said individual components having said attached same, similar or equivalent individual descriptions and definitions of enterprises, owners, human viewers and/or users of said individual components to said networked devices; and
vii. attaching individual identities of networked originating devices attaching to individual digital contents to individual identities of networked active receiving devices having attached same, similar or equivalent individual descriptions and definitions of enterprises, owners, human viewers and/or users of individual elements of individual components of said individual digital contents and attaching said individual elements having said attached same, similar or equivalent individual descriptions and definitions of enterprises, owners, human viewers and/or users of said individual elements of to said networked devices.

10. The method according to claim 8 wherein said process for said SPU applying said SPU-generated big data and analytics and statistics of said big data to choose and select networked originating devices, active receiving devices and passive receiving devices for sending, receiving, streaming, pushing, exchanging, shuffling, intermingling, composing, influencing and/or downloading relevant digital contents by, between and among said networked devices comprises processes for:
i. said individual networked originating devices to generate and submit to said SPU descriptions and definitions of individual enterprises, owners, human viewers and/or users of individual networked originating devices to identities of said individual networked originating devices, identities of individual networked originating devices to individual digital contents originating in said individual networked originating devices and said individual digital contents to descriptions and definitions of individual enterprises, owners, human viewers and/or users of said individual digital contents;
ii. said individual networked active receiving devices to generate and submit to said SPU descriptions and definitions of individual enterprises, owners, human viewers and/or users of individual networked active receiving devices to identities of said individual networked active receiving devices, identities of individual networked active receiving devices to individual digital contents originating in said individual networked active receiving devices and said individual digital contents to descriptions and definitions of individual enterprises, owners, human viewers and/or users of said individual digital contents;
iii. said individual networked passive receiving devices to generate and submit to said SPU descriptions and definitions of individual enterprises, owners, human viewers and/or users of individual networked passive receiving devices to identities of individual networked passive receiving devices;
iv. said SPU processing said submissions and outputting outcomes as SPU-generated big data in said memories;
v. said SPU to apply said SPU-generated big data and analytics and statistics of said big data to select networked originating devices, active receiving devices and passive receiving devices for generating, sending, receiving, streaming, pushing, exchanging, shuffling, intermingling, composing, influencing and/or downloading digital contents to and from, by, between and among said SPU-selected networked devices;
vi. attaching individual identities of said devices to descriptions and definitions of enterprises, owners, intended human viewers and/or users of said devices and attaching said individual identities of said devices to digital contents, said digital contents attaching to descriptions and definitions of enterprises, owners, intended human viewers and/or users of said digital contents choosing and selecting networked originating devices for sending, receiving, streaming, pushing, exchanging, shuffling, intermingling, composing, influencing and/or downloading relevant first digital contents and active receiving devices for receiving, streaming, pushing, exchanging, shuffling, intermingling, composing, influencing and/or downloading relevant said first digital contents consequent to said SPU relating descriptions and/or definitions of enterprises, owners, intended human viewers and/or users of said first digital contents attaching to said first digital contents attaching to chosen and/or selected identities of said originating devices to same, similar, analogous or approximate descriptions and definitions of enterprises, owners, intended human viewers and/or users of said active receiving devices attaching to identities of said active receiving devices attaching to second digital contents attaching to descriptions and/or definitions of enterprises, owners, intended human viewers and/or users of second digital contents;
vii. choosing and selecting said networked originating devices as active receiving devices for receiving said second digital contents attaching to descriptions and definitions of enterprises, owners, intended human viewers and/or users of said second digital contents attaching to identities of said active receiving devices by said SPU relating said descriptions and/or definitions of enterprises, owners, intended human viewers and/or users of said second digital contents to same, similar, analogous or approximate descriptions and/or definitions of enterprises, owners, intended human viewers and/or users of said originating devices for originating first digital contents;
viii. choosing and selecting said networked originating devices for originating first digital contents and passive receiving devices for receiving said first digital contents by relating descriptions and/or definitions of enterprises, owners, intended human viewers and/or users of first digital contents attaching to said digital contents attaching to SPU chosen and selected identities of said networked originating devices to same, similar, analogous or approximate descriptions and/or definitions of enterprises, owners, human viewers and/or users of passive receiving devices attaching to identities of said passive receiving devices; and
ix. choosing and selecting said networked active receiving devices for originating said second digital contents and passive receiving devices for receiving said second digital contents by relating descriptions and/or definitions of enterprises, owners, intended human viewers and/or users of second digital contents attaching to said digital contents attaching to chosen and selected identities of said networked active receiving devices to same, similar, analogous or approximate descriptions and/or definitions of enterprises, owners, human viewers and/or users of passive receiving devices attaching to identities of said passive receiving devices;

11. The method according to claim 8 wherein said process for said SPU applying changes or adaptation submitted by said devices to change or adapt said SPU-generated big data and analytics and statistics of said big data to adapt, assign and/or relocate devices in individual adaptable satellites to, between and/or among individual adaptable satellites to adapt said individual spheres of influence comprises:
said SPU to process said SPU-generated big data and analytics and statistics of said big data to constitute said devices constituents in individual adaptable satellites in said networked servers having individual spheres of influence;
said SPU attaching identities of individual devices attaching to same, similar, analogous or approximate descriptions and/or definitions of enterprises, owners, human viewers and/or users to an adaptable satellite comprising said devices attaching to same, similar, analogous or approximate descriptions and/or definitions of enterprises, owners, human viewers and/or users in said networked servers wherein said descriptions and/or definitions attaching to identities of said devices, descriptions and/or definitions of viewers and/or users and/or digital contents in said memories are adapted, updated and/or differed from previous individual versions of descriptions, definitions, digital contents by said SPU receiving individual adaptations, updates and/or changes in said descriptions, definitions, digital contents from said devices in said adaptable satellites in said constellation.

12. The method according to claim 8 wherein said process for said SPU applying said SPU-generated big data and analytics and statistics of said big data to effect said networked servers to send, receive, stream, push, exchange, shuffle, intermingle and compose said digital contents to and from, by, between and among said devices constituents in diverse places and domains in said individual adaptable satellites to generate and to overlap said spheres of influence of said adaptable satellites in said constellation comprises processes for:
said SPU applying said SPU-generated big data and analytics and statistics of said big data to choose and select networked originating devices, active receiving devices and passive receiving devices for sending, receiving, streaming, pushing, exchanging, shuffling, intermingling, composing, influencing and/or downloading relevant digital contents by, between and/or among said networked devices in said individual adaptable satellites;
moving or mobilizing stationary and mobile computers and mobile devices in individual adaptable satellites in, between and among diverse places and domains;
moving or mobilizing mobile display screens including flat-panel displays and digital mirrors and glass in individual adaptable satellites attaching to mobile supports in diverse public locations, places, facilities and settings in, between and among diverse places, locations, communities, towns, cities, states, countries and continents,
moving or mobilizing mobile display screens including flat-panel displays and digital mirrors and glass in individual adaptable satellites attaching to fixed and mobile supports attaching to mobile structures, frames, mobile vehicles, trains, boats, ships, airplanes, machines, inanimate structures and objects and animated objects in, between and among diverse communities, towns, cities, states, countries and continents.

13. The method according to claim 8 wherein said individual adaptable satellites to exert and project individual spheres of influence over devices constituents and selected and targeted SPU-selected and relevant enterprises, owners, human viewers and users of said networked devices in SPU-selected and targeted said diverse places and domains, said individual adaptable satellites to intermingle and overlap individual spheres of influence over diverse places and domains in said constellation comprises a process for said devices constituents in individual adaptable individual satellites to send, receive, stream, push, exchange, shuffle, intermingle, compose, influence and/or download said SPU-selected and relevant digital contents to and from, by, between and/or among said SPU-selected relevant devices constituents in diverse public places and domains.

14. In a system of networked display screens and flat-panel displays for specifying and instructing servers-processor units (SPU) of networked remote servers how to select networked display screens and flat-panel displays for generating, sending, receiving, exchanging, shuffling, intermingling, composing, influencing and downloading specific digital contents to and from, between and among said relevant networked display screens and flat-panel displays affixed to surfaces of diverse public places and domains, said networked display screens and flat-panel displays for sending, streaming and pushing said digital contents to targeted SPU-selected relevant desktops, mobile communication devices and televisions, said desktops, mobile communication devices and televisions for influencing and adapting said digital contents in and among said networked display screens and flat-panel displays in networks of said networked devices, a method for said networked display screens and flat-panel displays to specify and instruct said SPU how to select relevant networked originating, active and passive receiving display screens and flat-panel displays to generate, send, receive, exchange, shuffle, intermingle, compose, influence and download digital contents to and from, between and among said networked originating and receiving display screens and flat-panel displays and for said networked display screens and flat-panel displays to target relevant SPU-selected networked desktops, hand-held and mobile communication devices and televisions for sending, receiving, exchanging, shuffling, intermingling, composing, influencing and downloading specific digital contents to and from, between and among said networked devices, said method for said networked devices networked to said SPU to direct and guide domestic and global commerce, trades, businesses and transactions of goods and services, said method comprising processes for:
networking said adaptable satellites and servers comprising near-field communications, cable and wireless technologies and cloud-computing technologies, said adaptable satellites and servers comprising cable and wireless networking capabilities and near-field communications technologies, processors units coupled to memories;
attaching said networked display screens and groups of display screens including flat-panel displays and digital mirrors and glass to fixed and mobile supports in diverse public locations, places and settings in diverse communities, towns, cities, states, countries and continents;
said SPU to select relevant networked originating devices and receiving devices constituents in individual adaptable satellites from SPU-generated big data and analytics and statistics of said big data in said memories;
attaching to said SPU:
i. a mechanism for said big data and analytics and statistics of said big data for specifying and instructing said SPU how to attach individual identities of said devices constituents to descriptions and definitions of enterprises, owners, intended human viewers and/or users of said devices and how to attach said individual identities of said devices constituents to digital contents, how to attach said digital contents to descriptions and definitions of enterprises, owners, intended human viewers and/or users of said digital contents;
ii. a mechanism for said big data and analytics and statistics of said big data and analytics and statistics of said big data for specifying and instructing said SPU how to generate, grow and adapt said SPU-generated big data and analytics of said big data;
iii. a mechanism for said big data and analytics and statistics of said big data for specifying and instructing said SPU how to apply said SPU-generated big data, analytics and statistics how to constitute and adapt said networked originating devices and receiving devices for generating, sending, receiving, streaming, pushing, exchanging, shuffling, intermingling, composing, influencing and downloading digital contents to and from, by, between and among said SPU-selected networked devices constituents;
iv. a mechanism for said big data and analytics and statistics of said big data, analytics and statistics for specifying and instructing said SPU how to apply said SPU-generated big data to constitute said networked devices constituents for sending, receiving, streaming, pushing, exchanging, shuffling, intermingling, composing, influencing and/or downloading said digital contents to and from, by, between and among said networked devices constituents;
v. a mechanism for said big data and analytics and statistics of said big data, analytics and statistics for specifying and instructing said SPU how to apply said SPU-generated big data to constitute said networked originating display screens and flat-panel displays for generating, sending, receiving, exchanging, shuffling, intermingling, composing, influencing and downloading digital contents to and from, between and among said SPU select relevant networked originating and receiving display screens and flat-panel displays;
vi. a mechanism for said big data and analytics and statistics of said big data, analytics and statistics for specifying and instructing said SPU how to apply said SPU-generated big data to select networked originating and receiving display screens and flat-panel displays for specifying and instructing aid SPU how to select relevant networked originating devices, active receiving devices and passive receiving devices for generating, sending, receiving, exchanging, shuffling, intermingling, composing, influencing and downloading digital contents to and from, between and among said networked devices;
vii. a mechanism for said big data and analytics and statistics of said big data, analytics and statistics for specifying and instructing said SPU how to cause said servers to send, receive, stream, push, exchange, shuffle, intermingle, compose, influence and download said digital contents to and from, between and among said networked devices in said individual adaptable satellites in diverse public places and domains;
viii. a mechanism for said big data and analytics and statistics of said big data, analytics and statistics for specifying and instructing said SPU how to cause said remote servers to generate, send, receive, stream, push, exchange, shuffle, intermingle, compose, influence and download digital contents to and from, between and among SPU select relevant networked originating devices, active receiving devices and passive receiving devices;
ix. a mechanism for said big data and analytics and statistics of said big data, analytics and statistics for specifying and instructing said SPU how to deselect selected devices constituents;
x. a mechanism for said big data and analytics and statistics of said big data, analytics and statistics for specifying and instructing said SPU how to adapt, assigning and/or relocating individual devices constituents of, between and among individual adaptable satellites in said constellation of adaptable satellites to adapt and change individual spheres of influence;
xi. a mechanism for said big data and analytics and statistics of said big data, analytics and statistics for specifying and instructing said SPU how to analyze, adapt, improve and grow and said remote servers how to learn from said SPU-generated and analytics from submissions and adaptations generated and submitted by said networked devices constituents in said individual adaptable satellites and changing devices constituents;
xii. a mechanism for said big data and analytics and statistics of said big data, analytics and statistics for specifying and instructing said SPU how to learn how to analyze, adapt, improve and grow and said remote servers how to learn from said SPU-generated and analytics from continual inputs of said data from said networked devices to said SPU and into memories and how to apply said SPU-generated big data to automatically operate, sustain, support, grow and perpetuate said system, method, processes and outcomes generated by, between and among said networked devices;
xiii. a mechanism for specifying and instructing said processor units in said desktops, mobile devices and television how to influence and adapt digital contents in display screens and flat-panel displays;
xiv. a mechanism for said big data and analytics and statistics of said big data, analytics and statistics for specifying and instructing said processor units how to apply said SPU-generated big data, analytics and statistics to cause digital contents in display screens and flat-panel displays to be downloaded to and displayed in said SPU-selected desktops, mobile devices and televisions;
said individual networked originating devices to generate and submit to said SPU individual identities of said networked originating devices, individual descriptions and definitions of enterprises, owners, human viewers and/or users of said individual networked originating devices, digital contents in said individual networked originating devices, and individual descriptions and definitions of enterprises, owners, intended human viewers and/or users of said digital contents in said networked receiving devices;
said individual networked active receiving devices to generate and submit to said SPU individual identities of said networked active receiving devices, individual descriptions and definitions of enterprises, owners, intended human viewers and/or users of said networked active receiving devices, digital contents of said individual networked active receiving devices, and individual descriptions and definitions of enterprises, owners, intended human viewers and/or users of said digital contents;
said individual networked passive receiving devices to generate and submit to said SPU individual identities of said networked passive receiving devices, individual descriptions and definitions of enterprises, owners, intended human viewers and/or users of said individual networked passive receiving devices;
said networked display screens and flat-panel displays, desktops, mobile devices, televisions networked to said SPU to send, receive, stream, push, exchange, shuffle, intermingle, compose, influence and download said digital contents to and from, between and among said networked devices in said individual adaptable satellites;
said networked display screens and flat-panel displays for generating, sending, streaming and pushing digital contents of said networked display screens and flat-panel displays to said SPU-selected networked devices;
said networked display screens and flat-panel displays to send, receive, stream, push, exchange, shuffle, intermingle, compose, influence and download digital contents to and from SPU-selected desktops, mobile devices and televisions;
said networked desktops, mobile devices and televisions to influence and adapt said digital contents of, between and among said networked devices;
said networked display screens and flat-panel displays to cause said desktops, mobile devices and televisions to send, stream and push digital contents to remote display screens and flat-panel displays in said individual adaptable satellites;
said SPU applying changes or adaptations submitted by said networked devices constituents to adapt, assign and/or relocate individual SPU-selected networked devices constituents of, between and among individual adaptable satellites in said constellation of adaptable satellites;
said SPU generating, growing and adapting said SPU-generated big data in said memories;
said SPU applying said SPU-generated big data and analytics and statistics of said big data to:
i. select networked display screens and flat-panel displays and networked desktops, mobile devices and televisions in individual adaptable satellites;
ii. adapt, assign and/or relocate individual SPU-selected networked devices constituents of, between and among individual adaptable satellites in said constellation of adaptable satellites;
iii. create, maintain and adapt said SPU-selected digital contents of, between and among said networked devices in individual adaptable satellites;
iv. cause said remote servers to create, maintain and adapt said SPU-selected networked devices constituents for generating, sending, receiving, streaming, pushing, exchanging, shuffling, intermingling, composing, influencing and downloading SPU-selected digital contents to and from, between and among SPU-selected networked devices in individual adaptable satellites;
said SPU for applying said big data and analytics and statistics of said big data to cause said remote servers to repeatedly and predictably or reliably:
i. constitute and adapt individual networked devices constituents in individual adaptable satellites and between and among said individual adaptable satellites;
ii. send, receive, exchange, shuffle, intermingle, compose, influence and download said diverse and wide spectrum of digital contents to and from, by, between and among SPU-selected networked devices;
iii. direct, guide, expedite and enhance domestic and global trades, commerce, businesses and transactions of goods and services;
said individual adaptable satellites projecting and exerting individual spheres of influence over devices constituents and selected and targeted SPU-selected and relevant enterprises, owners, human viewers and users of said devices in SPU-selected and targeted said diverse places and domains, said individual adaptable satellites to intermingle and overlap individual spheres of influence in said constellation;
said SPU applying said SPU-generated big data and analytics and statistics of said big data to effect said networked servers to send, receive, stream, push, exchange, shuffle, intermingle and compose said digital contents to and from, by, between and among said devices constituents in diverse places and domains in said individual adaptable satellites to generate and to overlap said spheres of influence of said adaptable satellites in said constellation.

15. The method according to claim 14 wherein said process for said SPU applying changes or adaptation submitted by said devices to change or adapt said SPU-generated big data and analytics and statistics of said big data to adapt, assign and/or relocate devices in individual adaptable satellites to, between and/or among individual adaptable satellites to adapt said individual spheres of influence comprises:
said SPU to process said SPU-generated big data and analytics and statistics of said big data to constitute said devices constituents in individual adaptable satellites in said networked servers having individual spheres of influence;
said SPU attaching identities of individual devices attaching to same, similar, analogous or approximate descriptions and/or definitions of enterprises, owners, human viewers and/or users to an adaptable satellite comprising said devices attaching to same, similar, analogous or approximate descriptions and/or definitions of enterprises, owners, human viewers and/or users in said networked servers wherein said descriptions and/or definitions attaching to identities of said devices, descriptions and/or definitions of viewers and/or users and/or digital contents in said memories are adapted, updated and/or differed from previous individual versions of descriptions, definitions, digital contents by said SPU receiving individual adaptations, updates and/or changes in said descriptions, definitions, digital contents from said devices in said adaptable satellites in said constellation.

16. The method according to claim 14 wherein said process for said SPU applying said SPU-generated big data and analytics and statistics of said big data to effect said networked servers to send, receive, stream, push, exchange, shuffle, intermingle and compose said digital contents to and from, by, between and among said devices constituents in diverse places and domains in said individual adaptable satellites to generate and to overlap said spheres of influence of said adaptable satellites in said constellation comprises processes for:
said SPU applying said SPU-generated big data and analytics and statistics of said big data to choose and select networked originating devices, active receiving devices and passive receiving devices for sending, receiving, streaming, pushing, exchanging, shuffling, intermingling, composing, influencing and/or downloading relevant digital contents by, between and/or among said networked devices in said individual adaptable satellites;
moving or mobilizing stationary and mobile computers and mobile devices in individual adaptable satellites in, between and among diverse places and domains;
moving or mobilizing mobile display screens including flat-panel displays and digital mirrors and glass in individual adaptable satellites attaching to mobile supports in diverse public locations, places, facilities and settings in, between and among diverse places, locations, communities, towns, cities, states, countries and continents,
moving or mobilizing mobile display screens including flat-panel displays and digital mirrors and glass in individual adaptable satellites attaching to fixed and mobile supports attaching to mobile structures, frames, mobile vehicles, trains, boats, ships, airplanes, machines, inanimate structures and objects and animated objects in, between and among diverse communities, towns, cities, states, countries and continents.
